(19) United States
(12) Patent Application Publication
(10) Pub. No.: US 2012/0290821 A1
(43) Pub. Date: Nov. 15, 2012

(54) LOW-LATENCY BRANCH TARGET CACHE

(76) Inventors: Manish K. Shah, Austin, TX (US); Gregory F. Grohoski, Bee Cave, TX (US)

(21) Appl. No.: 13/105,606

(22) Filed: May 11, 2011

(51) Int. Cl. G06F 9/38

(52) U.S. Cl. 712/240; 712/E09.045

(57) ABSTRACT

Techniques and structures are disclosed relating to a branch target cache (BTC) in a processor. In one embodiment, the BTC is usable to predict whether a control transfer instruction is to be taken, and, if applicable, a target address for the instruction. The BTC may operate in conjunction with a delayed branch predictor (DBP) that is more accurate but slower than the BTC. If the BTC indicates that a control transfer instruction is predicted to be taken, the processor begins to fetch instructions at the target address indicated by the BTC, but may discard those instructions if the DBP subsequently determines that the control transfer instruction was predicted incorrectly. Branch prediction information output from the BTC and the DBP may be used to update the branch target cache for subsequent predictions. In various embodiments, the BTC may simultaneously store entries for multiple processor threads, and may be fully associative.

### BACKGROUND

1. Technical Field

This disclosure relates to processors, and more specifically to branch prediction within processors.

2. Description of the Related Art

Many modern microprocessors achieve increased performance by executing multiple instructions in parallel and out-of program-order. The execution of certain instructions, however, can result in a significant loss of performance. Consider control transfer instructions (CTIs) such as branches, calls, and returns, which are highly prevalent in most programs. The execution of these instructions can cause pipelined microprocessors to stall because the instructions to be executed after a CTI are not known until the CTI is finalized.

Many modern microprocessors employ branch prediction techniques to speculatively fetch and execute instructions beyond a CTI. In a typical branch prediction scenario, when a CTI is mispredicted, instructions speculatively fetched beyond the CTI are discarded, and new instructions are fetched from the correct path. Such mispredictions result in loss of performance and waste of power. To mitigate these effects, many high-performance microprocessors include very accurate branch predictor units. For example, some microprocessors employ a two-level predictor or an adaptive perceptron algorithm to achieve high prediction accuracy. One disadvantage of these highly accurate predictors is high latency. For example, at high clock frequencies, it may take some prediction units two to three cycles to output a prediction. For convenience, certain high-accuracy, high-latency predictors described herein are referred to as delayed branch predictors (DBPs).

Accordingly, when an instruction fetch unit (IFU), a typical portion of a processor tasked with providing instructions to execution units, encounters a CTI, it may have to wait for 2-3 cycles for the DBP to determine that the CTI is predicted to be taken. Once the CTI is determined to be predicted-taken, the IFU has to fetch instructions from the target address of the CTI. This delay (the “taken-branch penalty”) in determining the prediction of the CTI results in wasted cycles, loss in performance, and increased power consumption.

### SUMMARY

A processing element including a first branch prediction unit and a second, higher-latency branch prediction unit is disclosed. The first branch prediction unit may be a branch target cache (BTC) in some embodiments, and the second branch prediction unit may be referred to as a delayed branch predictor (DBP) in some embodiments. Upon the processing element encountering a control transfer instruction (CTI), both the first and second branch prediction units generate corresponding prediction information (e.g., direction and/or target address). The first branch prediction unit is configured to generate its prediction information before the second prediction unit for a given control transfer instruction. Upon the second branch prediction unit completing generation of its prediction information, any needed updates to the program flow (e.g., instruction refetch) and/or the first branch prediction unit may be performed.

For example, if the first branch prediction unit generates prediction information indicating that a control transfer instruction is predicted to be taken, the processing element may begin fetching instructions at the target of that control transfer instruction (which may be stored the first branch prediction unit in some embodiments). If the second branch prediction unit (which is slower, but more accurate than the first branch prediction unit in some embodiments) subsequently indicates the control transfer instruction is predicted to not be taken, the fetched instructions may be discarded, and information stored in the first branch prediction unit may be updated (e.g., to cause the first branch prediction unit to predict the next occurrence of the first branch prediction unit to not be taken). In this manner, the first branch prediction unit may, in some instances, reduce power consumption and mitigate processor performance loss due to the taken-branch penalty.

In one embodiment, the first branch prediction unit may be designed to predict direction and target for all threads running on a multithreaded processor. The first branch prediction unit may be designed such that a CTI in one thread does not influence the prediction of a CTI running in another thread. Additionally, the first branch prediction unit may be fully associative. In one particular implementation, the first branch prediction unit is a fully associative BTC and the second branch prediction implements any suitable branch prediction mechanism. The BTC in this embodiment includes a 32-entry tag array storing a valid bit, a used bit, and a tag, as well as a 32-entry data array with target addresses. This particular BTC may generate its prediction information with a 1-cycle taken-branch penalty, an improvement over the more significant taken-branch penalties corresponding to the second branch prediction unit.

### BRIEF DESCRIPTION OF THE DRAWINGS

FIG. 1 is a block diagram illustrating one embodiment of an exemplary processor.

FIG. 2 is a block diagram illustrating one embodiment of an exemplary processor core.

FIG. 3 is a block diagram illustrating one embodiment of a multithreaded processor core that includes two branch predictors.

FIG. 4 is a block diagram illustrating one embodiment of a branch prediction unit that includes a branch target cache and delayed branch predictor.

FIG. 5 is a block diagram illustrating two embodiments of tag array entries within an implementation of a branch target cache.

FIG. 6 is an exemplary table setting forth actions taken to update a branch target cache according to one embodiment.

FIG. 7 is a flow diagram illustrating one embodiment of a method of branch prediction.

FIG. 8 is a diagram illustrating examples of branch prediction penalties in one embodiment of a processor core.

FIG. 9 is a block diagram illustrating one embodiment of an exemplary system.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component.

“First,” “Second,” etc. As used herein, these terms are used as labels for nouns that they precede, and do not imply any type of ordering (e.g., spatial, temporal, logical, etc.). For example, in a processor having two branch prediction units, the terms “first” and “second” are merely labels used to refer to either of these units.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Execute.” This term has its ordinary and accepted meaning in the art, and includes all actions that may be performed by a processor to effectuate the completion of the instruction, including fetch, decode, issue, as well as actually computing the result of the instruction. When a functional unit is described herein as “executing” a particular instruction, this term refers to computing a result of the particular instruction (e.g., computing the sum of the contents of two registers).

“Thread.” This term has its ordinary and accepted meaning in the art, and includes a set of instructions within a program that is executable by a processor. The term “thread” may, for example, refer to a group of instructions executing on a processor as a result of a “fork” or other similar operation. Instructions described herein as being “in” a thread are a part of the set of instructions for a thread.

“Concurrently Storing/Simultaneously Storing.” As used herein, these phrases refer to storing items (e.g., prediction information for different threads) for some overlapping period. Note that these phrases do not necessary imply that the storage of two concurrently stored items begins at the same time or that the two items are stored for the same length of time. For example, a first set of prediction information for a first thread and a second set of prediction information for a second thread are concurrently stored or simultaneously stored if a first set of prediction information is stored for period of time t₀-t₁, a second set of prediction information is stored for a period of time t₂-t₃, and times t₂ or t₃ occurs between times t₀ and t₁.

### Introduction

As noted above, a first branch prediction unit is disclosed in conjunction with a second, higher-latency branch prediction unit. Prediction information generated by the first branch prediction unit may be used to predict program flow; the predicted program flow and/or information stored in the first branch prediction unit may be updated once the prediction information generated by the second branch prediction unit is generated. The first branch prediction unit may, in some embodiments, reduce the taken-branch penalty associated with the second branch prediction unit.

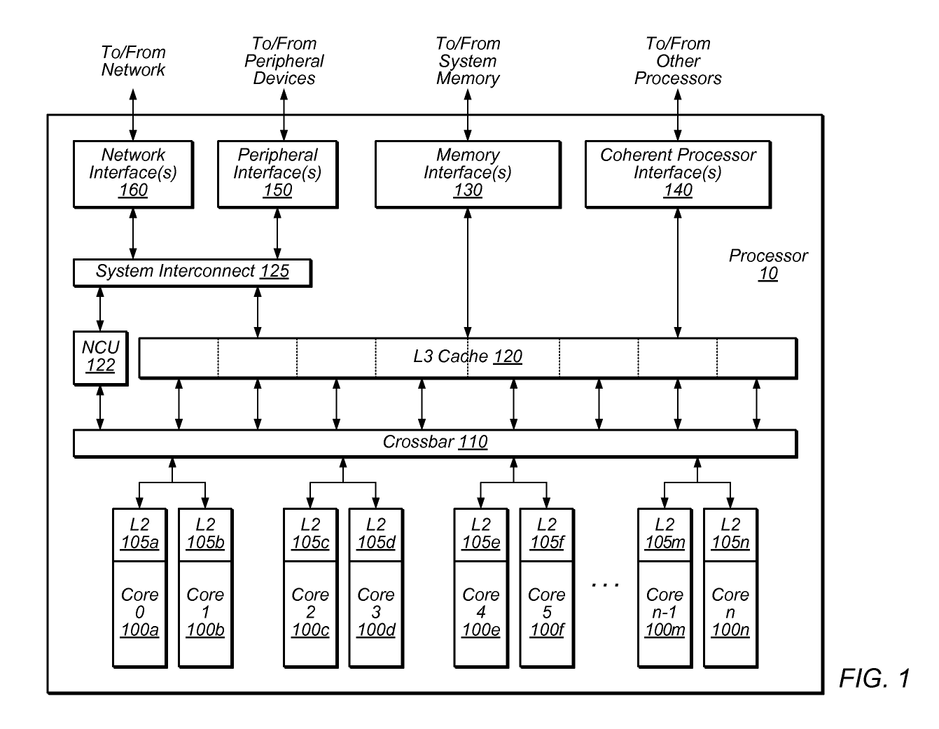

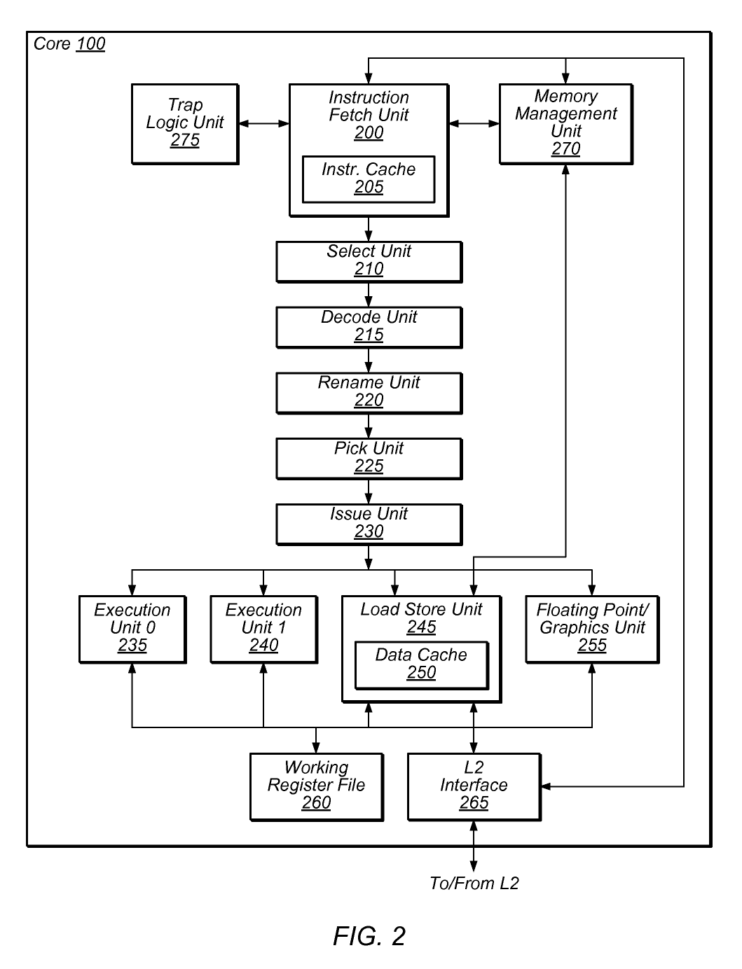

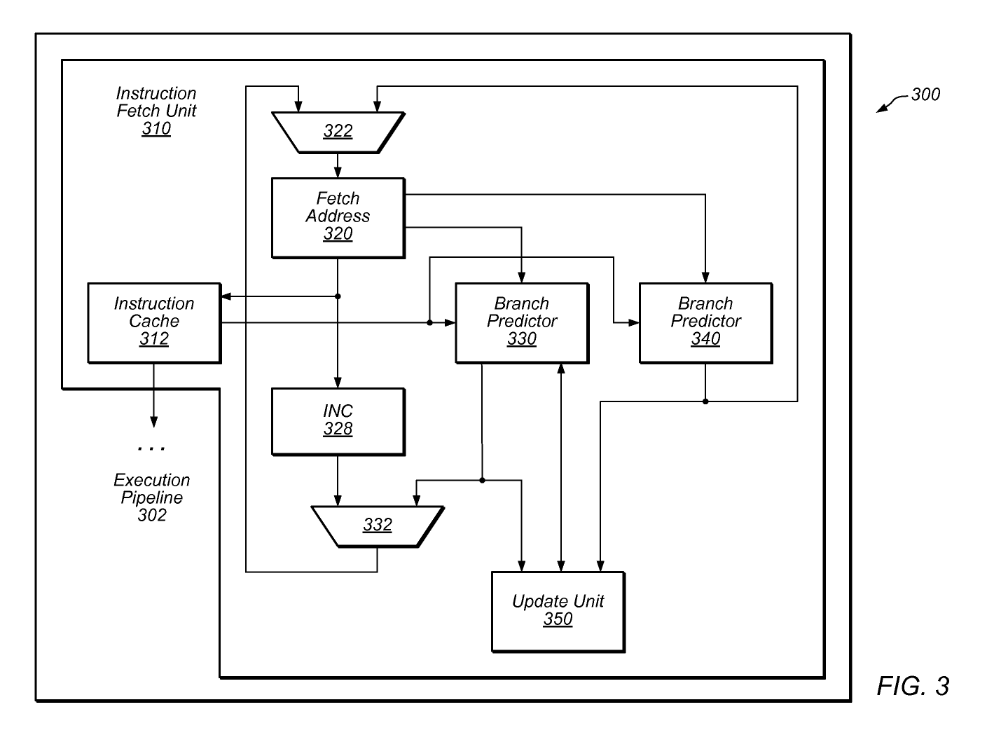

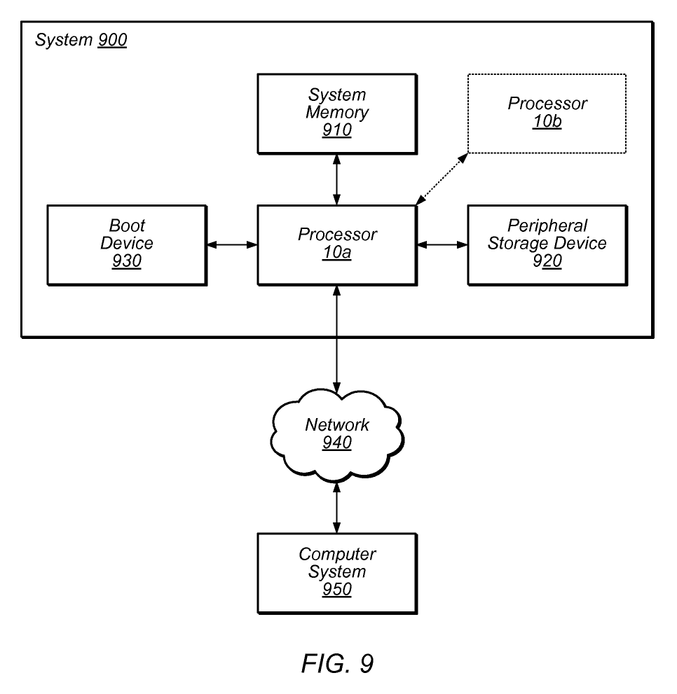

The present disclosure describes various embodiments relating to a branch prediction unit operating in conjunction with another, relatively higher-latency branch prediction unit. FIGS. 1 and 2 present an overview of an exemplary multithreaded processor in which such branch prediction units may be included. FIGS. 3-8 describe various structures and features relating to embodiments of a relatively low-latency branch prediction unit. FIG. 9 presents an overview of a computer system in which such a branch prediction unit may be used.

### General Overview of a Multithreaded Processor

Turning now to FIG. 1, a block diagram illustrating one embodiment of a processor 10 is shown. In certain embodiments, processor 10 may be multithreaded. In the illustrated embodiment, processor 10 includes a number of processor cores 100a-n, which are also designated “core 0” though “core n.” As used herein, the term processor may refer to an apparatus having a single processor core or an apparatus that includes two or more processor cores. Various embodiments of processor 10 may include varying numbers of cores 100, such as 8, 16, or any other suitable number. Each of cores 100 is coupled to a corresponding L2 cache 105a-n, which in turn couple to L3 cache 120 via a crossbar 110. Cores 100a-n and L2 caches 105a-n may be generically referred to, either collectively or individually, as core(s) 100 and L2 cache(s) 105, respectively.

Via crossbar 110 and L3 cache 120, cores 100 may be coupled to a variety of devices that may be located externally to processor 10. In the illustrated embodiment, one or more memory interface(s) 130 may be configured to couple to one or more banks of system memory (not shown). One or more coherent processor interface(s) 140 may be configured to couple processor 10 to other processors (e.g., in a multiprocessor environment employing multiple units of processor 10). Additionally, system interconnect 125 couples cores 100 to one or more peripheral interface(s) 150 and network interface(s) 160. As described in greater detail below, these interfaces may be configured to couple processor 10 to various peripheral devices and networks.

Cores 100 may be configured to execute instructions and to process data according to a particular instruction set architecture (ISA). In one embodiment, cores 100 may be configured to implement a version of the SPARC® ISA, such as SPARC® V9, UltraSPARC Architecture 2005, UltraSPARC Architecture 2007, or UltraSPARC Architecture 2009, for example. However, in other embodiments it is contemplated that any desired ISA may be employed, such as x86 (32-bit or 64-bit versions), PowerPC® or MIPS®, for example.

In the illustrated embodiment, each of cores 100 may be configured to operate independently of the others, such that all cores 100 may execute in parallel (i.e., concurrently). Additionally, as described below in conjunction with the descriptions of FIG. 2, in some embodiments, each of cores 100 may be configured to execute multiple threads concurrently, where a given thread may include a set of instructions that may execute independently of instructions from another thread. (For example, an individual software process, such as an application, may consist of one or more threads that may be scheduled for execution by an operating system.) Such a core 100 may also be referred to as a multithreaded (MT) core. In one embodiment, each of cores 100 may be configured to concurrently execute instructions from a variable number of threads, up to eight concurrently-executing threads. In a 16-core implementation, processor 10 could thus concurrently execute up to 128 threads. However, in other embodiments it is contemplated that other numbers of cores 100 may be provided, and that cores 100 may concurrently process different numbers of threads.

Additionally, as described in greater detail below, in some embodiments, each of cores 100 may be configured to execute certain instructions out of program order, which may also be referred to herein as out-of-order execution, or simply OOO. As an example of out-of-order execution, for a particular thread, there may be instructions that are subsequent in program order to a given instruction yet do not depend on the given instruction. If execution of the given instruction is delayed for some reason (e.g., owing to a cache miss), the later instructions may execute before the given instruction completes, which may improve overall performance of the executing thread.

As shown in FIG. 1, in one embodiment, each core 100 may have a dedicated corresponding L2 cache 105. In one embodiment, L2 cache 105 may be configured as a set-associative, write-back cache that is fully inclusive of first-level cache state (e.g., instruction and data caches within core 100). To maintain coherence with first-level caches, embodiments of L2 cache 105 may implement a reverse directory that maintains a virtual copy of the first-level cache tags. L2 cache 105 may implement a coherence protocol (e.g., the MESI protocol) to maintain coherence with other caches within processor 10. In one embodiment, L2 cache 105 may enforce a Total Store Ordering (TSO) model of execution in which all store instructions from the same thread complete in program order.

In various embodiments, L2 cache 105 may include a variety of structures configured to support cache functionality and performance. For example, L2 cache 105 may include a miss buffer configured to store requests that miss the L2, a fill buffer configured to temporarily store data returning from L3 cache 120, a write-back buffer configured to temporarily store dirty evicted data and snoop copyback data, and/or a snoop buffer configured to store snoop requests received from L3 cache 120. In one embodiment, L2 cache 105 may implement a history-based prefetcher that may attempt to analyze L2 miss behavior and correspondingly generate prefetch requests to L3 cache 120.

Crossbar 110 may be configured to manage data flow between L2 caches 105 and the shared L3 cache 120. In one embodiment, crossbar 110 may include logic (such as multiplexers or a switch fabric, for example) that allows any L2 cache 105 to access any bank of L3 cache 120, and that conversely allows data to be returned from any L3 bank to any L2 cache 105. That is, crossbar 110 may be configured as an M-to-N crossbar that allows for generalized point-to-point communication. However, in other embodiments, other interconnection schemes may be employed between L2 caches 105 and L3 cache 120. For example, a mesh, ring, or other suitable topology may be utilized.

Crossbar 110 may be configured to concurrently process data requests from L2 caches 105 to L3 cache 120 as well as data responses from L3 cache 120 to L2 caches 105. In some embodiments, crossbar 110 may include logic to queue data requests and/or responses, such that requests and responses may not block other activity while waiting for service. Additionally, in one embodiment crossbar 110 may be configured to arbitrate conflicts that may occur when multiple L2 caches 105 attempt to access a single bank of L3 cache 120, or vice versa.

L3 cache 120 may be configured to cache instructions and data for use by cores 100. In the illustrated embodiment, L3 cache 120 may be organized into eight separately addressable banks that may each be independently accessed, such that in the absence of conflicts, each bank may concurrently return data to a respective L2 cache 105. In some embodiments, each individual bank may be implemented using set-associative or direct-mapped techniques. For example, in one embodiment, L3 cache 120 may be an 8 megabyte (MB) cache, where each 1 MB bank is 16-way set associative with a 64-byte line size. L3 cache 120 may be implemented in some embodiments as a write-back cache in which written (dirty) data may not be written to system memory until a corresponding cache line is evicted. However, it is contemplated that in other embodiments, L3 cache 120 may be configured in any suitable fashion. For example, L3 cache 120 may be implemented with more or fewer banks, or in a scheme that does not employ independently-accessible banks; it may employ other bank sizes or cache geometries (e.g., different line sizes or degrees of set associativity); it may employ write through instead of write-back behavior; and it may or may not allocate on a write miss. Other variations of L3 cache 120 configuration are possible and contemplated.

In some embodiments, L3 cache 120 may implement queues for requests arriving from and results to be sent to crossbar 110. Additionally, in some embodiments L3 cache 120 may implement a fill buffer configured to store fill data arriving from memory interface 130, a write-back buffer configured to store dirty evicted data to be written to memory, and/or a miss buffer configured to store L3 cache accesses that cannot be processed as simple cache hits (e.g., L3 cache misses, cache accesses matching older misses, accesses such as atomic operations that may require multiple cache accesses, etc.). L3 cache 120 may variously be implemented as single-ported or multiported (i.e., capable of processing multiple concurrent read and/or write accesses). In either case, L3 cache 120 may implement arbitration logic to prioritize cache access among various cache read and write requestors.

Not all external accesses from cores 100 necessarily proceed through L3 cache 120. In the illustrated embodiment, non-cacheable unit (NCU) 122 may be configured to process requests from cores 100 for non-cacheable data, such as data from I/O devices as described below with respect to peripheral interface(s) 150 and network interface(s) 160.

Memory interface 130 may be configured to manage the transfer of data between L3 cache 120 and system memory, for example in response to cache fill requests and data evictions. In some embodiments, multiple instances of memory interface 130 may be implemented, with each instance configured to control a respective bank of system memory. Memory interface 130 may be configured to interface to any suitable type of system memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), or Rambus® DRAM (RDRAM®), for example. In some embodiments, memory interface 130 may be configured to support interfacing to multiple different types of system memory.

In the illustrated embodiment, processor 10 may also be configured to receive data from sources other than system memory. System interconnect 125 may be configured to provide a central interface for such sources to exchange data with cores 100, L2 caches 105, and/or L3 cache 120. In some embodiments, system interconnect 125 may be configured to coordinate Direct Memory Access (DMA) transfers of data to and from system memory. For example, via memory interface 130, system interconnect 125 may coordinate DMA transfers between system memory and a network device attached via network interface 160, or between system memory and a peripheral device attached via peripheral interface 150.

Processor 10 may be configured for use in a multiprocessor environment with other instances of processor 10 or other compatible processors. In the illustrated embodiment, coherent processor interface(s) 140 may be configured to implement high-bandwidth, direct chip-to-chip communication between different processors in a manner that preserves memory coherence among the various processors (e.g., according to a coherence protocol that governs memory transactions).

Peripheral interface 150 may be configured to coordinate data transfer between processor 10 and one or more peripheral devices. Such peripheral devices may include, for example and without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, peripheral interface 150 may implement one or more instances of a standard peripheral interface. For example, one embodiment of peripheral interface 150 may implement the Peripheral Component Interface Express (PCI Express™ or PCIe) standard according to generation 1.x, 2.0, 3.0, or another suitable variant of that standard, with any suitable number of I/O lanes. However, it is contemplated that any suitable interface standard or combination of standards may be employed. For example, in some embodiments peripheral interface 150 may be configured to implement a version of Universal Serial Bus (USB) protocol or IEEE 1394 (Firewire®) protocol in addition to or instead of PCI Express™.

Network interface 160 may be configured to coordinate data transfer between processor 10 and one or more network devices (e.g., networked computer systems or peripherals) coupled to processor 10 via a network. In one embodiment, network interface 160 may be configured to perform the data processing necessary to implement an Ethernet (IEEE 802.3) networking standard such as Gigabit Ethernet or 10-Gigabit Ethernet, for example. However, it is contemplated that any suitable networking standard may be implemented, including forthcoming standards such as 40-Gigabit Ethernet and 100-Gigabit Ethernet. In some embodiments, network interface 160 may be configured to implement other types of networking protocols, such as Fibre Channel, Fibre Channel over Ethernet (FCoE), Data Center Ethernet, Infiniband, and/or other suitable networking protocols. In some embodiments, network interface 160 may be configured to implement multiple discrete network interface ports.

### Overview of Dynamic Multithreading Processor Core

As mentioned above, in one embodiment each of cores 100 may be configured for multithreaded, out-of-order execution. More specifically, in one embodiment, each of cores 100 may be configured to perform dynamic multithreading. Generally speaking, under dynamic multithreading, the execution resources of cores 100 may be configured to efficiently process varying types of computational workloads that exhibit different performance characteristics and resource requirements. Such workloads may vary across a continuum that emphasizes different combinations of individual-thread and multiple-thread performance.

At one end of the continuum, a computational workload may include a number of independent tasks, where completing the aggregate set of tasks within certain performance criteria (e.g., an overall number of tasks per second) is a more significant factor in system performance than the rate at which any particular task is completed. For example, in certain types of server or transaction processing environments, there may be a high volume of individual client or customer requests (such as web page requests or file system accesses). In this context, individual requests may not be particularly sensitive to processor performance. For example, requests may be I/O-bound rather than processor-bound—completion of an individual request may require I/O accesses (e.g., to relatively slow memory, network, or storage devices) that dominate the overall time required to complete the request, relative to the processor effort involved. Thus, a processor that is capable of concurrently processing many such tasks (e.g., as independently executing threads) may exhibit better performance on such a workload than a processor that emphasizes the performance of only one or a small number of concurrent tasks.

At the other end of the continuum, a computational workload may include individual tasks whose performance is highly processor-sensitive. For example, a task that involves significant mathematical analysis and/or transformation (e.g., cryptography, graphics processing, scientific computing) may be more processor-bound than I/O-bound. Such tasks may benefit from processors that emphasize single-task performance, for example through speculative execution and exploitation of instruction-level parallelism.

Dynamic multithreading represents an attempt to allocate processor resources in a manner that flexibly adapts to workloads that vary along the continuum described above. In one embodiment, cores 100 may be configured to implement fine-grained multithreading, in which each core may select instructions to execute from among a pool of instructions corresponding to multiple threads, such that instructions from different threads may be scheduled to execute adjacently. For example, in a pipelined embodiment of core 100 employing fine-grained multithreading, instructions from different threads may occupy adjacent pipeline stages, such that instructions from several threads may be in various stages of execution during a given core processing cycle. Through the use of fine-grained multithreading, cores 100 may be configured to efficiently process workloads that depend more on concurrent thread processing than individual thread performance.

In one embodiment, cores 100 may also be configured to implement out-of-order processing, speculative execution, register renaming and/or other features that improve the performance of processor-dependent workloads. Moreover, cores 100 may be configured to dynamically allocate a variety of hardware resources among the threads that are actively executing at a given time, such that if fewer threads are executing, each individual thread may be able to take advantage of a greater share of the available hardware resources. This may result in increased individual thread performance when fewer threads are executing, while retaining the flexibility to support workloads that exhibit a greater number of threads that are less processor-dependent in their performance. In various embodiments, the resources of a given core 100 that may be dynamically allocated among a varying number of threads may include branch resources (e.g., branch predictor structures), load/store resources (e.g., load/store buffers and queues), instruction completion resources (e.g., reorder buffer structures and commit logic), instruction issue resources (e.g., instruction selection and scheduling structures), register rename resources (e.g., register mapping tables), and/or memory management unit resources (e.g., translation lookaside buffers, page walk resources).

One embodiment of core 100 that is configured to perform dynamic multithreading is illustrated in FIG. 2. In the illustrated embodiment, core 100 includes an instruction fetch unit (IFU) 200 that includes an instruction cache 205. IFU 200 is coupled to a memory management unit (MMU) 270, L2 interface 265, and trap logic unit (TLU) 275. IFU 200 is additionally coupled to an instruction processing pipeline that begins with a select unit 210 and proceeds in turn through a decode unit 215, a rename unit 220, a pick unit 225, and an issue unit 230. Issue unit 230 is coupled to issue instructions to any of a number of instruction execution resources: an execution unit 0 (EXU0) 235, an execution unit 1 (EXU1) 240, a load store unit (LSU) 245 that includes a data cache 250, and/or a floating-point/graphics unit (FGU) 255. These instruction execution resources are coupled to a working register file 260. Additionally, LSU 245 is coupled to L2 interface 265 and MMU 270.

In the following discussion, exemplary embodiments of each of the structures of the illustrated embodiment of core 100 are described. However, it is noted that the illustrated partitioning of resources is merely one example of how core 100 may be implemented. Alternative configurations and variations are possible and contemplated.

Instruction fetch unit 200 may be configured to provide instructions to the rest of core 100 for execution. In one embodiment, IFU 200 may be configured to select a thread to be fetched, fetch instructions from instruction cache 205 for the selected thread and buffer them for downstream processing, request data from L2 cache 105 in response to instruction cache misses, and predict the direction and target of control transfer instructions (e.g., branches). In some embodiments, IFU 200 may include a number of data structures in addition to instruction cache 205, such as an instruction translation lookaside buffer (ITLB), instruction buffers, and/or structures configured to store state that is relevant to thread selection and processing.

In one embodiment, during each execution cycle of core 100, IFU 200 may be configured to select one thread that will enter the IFU processing pipeline. Thread selection may take into account a variety of factors and conditions, some thread-specific and others IFU-specific. For example, certain instruction cache activities (e.g., cache fill), ITLB activities, or diagnostic activities may inhibit thread selection if these activities are occurring during a given execution cycle. Additionally, individual threads may be in specific states of readiness that affect their eligibility for selection. For example, a thread for which there is an outstanding instruction cache miss may not be eligible for selection until the miss is resolved. In some embodiments, those threads that are eligible to participate in thread selection may be divided into groups by priority, for example depending on the state of the thread or of the ability of the IFU pipeline to process the thread. In such embodiments, multiple levels of arbitration may be employed to perform thread selection: selection occurs first by group priority, and then within the selected group according to a suitable arbitration algorithm (e.g., a least-recently-fetched algorithm). However, it is noted that any suitable scheme for thread selection may be employed, including arbitration schemes that are more complex or simpler than those mentioned here.

Once a thread has been selected for fetching by IFU 200, instructions may actually be fetched for the selected thread. To perform the fetch, in one embodiment, IFU 200 may be configured to generate a fetch address to be supplied to instruction cache 205. In various embodiments, the fetch address may be generated as a function of a program counter associated with the selected thread, a predicted branch target address, or an address supplied in some other manner (e.g., through a test or diagnostic mode). The generated fetch address may then be applied to instruction cache 205 to determine whether there is a cache hit.

In some embodiments, accessing instruction cache 205 may include performing fetch address translation (e.g., in the case of a physically indexed and/or tagged cache), accessing a cache tag array, and comparing a retrieved cache tag to a requested tag to determine cache hit status. If there is a cache hit, IFU 200 may store the retrieved instructions within buffers for use by later stages of the instruction pipeline. If there is a cache miss, IFU 200 may coordinate retrieval of the missing cache data from L2 cache 105. In some embodiments, IFU 200 may also be configured to prefetch instructions into instruction cache 205 before the instructions are actually required to be fetched. For example, in the case of a cache miss, IFU 200 may be configured to retrieve the missing data for the requested fetch address as well as addresses that sequentially follow the requested fetch address, on the assumption that the following addresses are likely to be fetched in the near future.

In many ISAs, instruction execution proceeds sequentially according to instruction addresses (e.g., as reflected by one or more program counters). However, control transfer instructions (CTIs) such as branches, call/return instructions, or other types of instructions may cause the transfer of execution from a current fetch address to a nonsequential address. As mentioned above, IFU 200 may be configured to predict the direction and target of CTIs (or, in some embodiments, a subset of the CTIs that are defined for an ISA) in order to reduce the delays incurred by waiting until the effect of a CTI is known with certainty. In one embodiment, IFU 200 may be configured to implement a perceptron-based dynamic branch predictor, although any suitable type of branch predictor may be employed.

To implement branch prediction, IFU 200 may implement a variety of control and data structures in various embodiments, such as history registers that track prior branch history, weight tables that reflect relative weights or strengths of predictions, and/or target data structures that store fetch addresses that are predicted to be targets of a CTI. Also, in some embodiments, IFU 200 may further be configured to partially decode (or predecode) fetched instructions in order to facilitate branch prediction. A predicted fetch address for a given thread may be used as the fetch address when the given thread is selected for fetching by IFU 200. The outcome of the prediction may be validated when the CTI is actually executed (e.g., if the CTI is a conditional instruction, or if the CTI itself is in the path of another predicted CTI). If the prediction was incorrect, instructions along the predicted path that were fetched and issued may be cancelled.

Through the operations discussed above, IFU 200 may be configured to fetch and maintain a buffered pool of instructions from one or multiple threads, to be fed into the remainder of the instruction pipeline for execution. Generally speaking, select unit 210 may be configured to select and schedule threads for execution. In one embodiment, during any given execution cycle of core 100, select unit 210 may be configured to select up to one ready thread out of the maximum number of threads concurrently supported by core 100 (e.g., 8 threads), and may select up to two instructions from the selected thread for decoding by decode unit 215, although in other embodiments, a differing number of threads and instructions may be selected. In various embodiments, different conditions may affect whether a thread is ready for selection by select unit 210, such as branch mispredictions, unavailable instructions, or other conditions. To ensure fairness in thread selection, some embodiments of select unit 210 may employ arbitration among ready threads (e.g. a least-recently-used algorithm).

The particular instructions that are selected for decode by select unit 210 may be subject to the decode restrictions of decode unit 215; thus, in any given cycle, fewer than the maximum possible number of instructions may be selected. Additionally, in some embodiments, select unit 210 may be configured to allocate certain execution resources of core 100 to the selected instructions, so that the allocated resources will not be used for the benefit of another instruction until they are released. For example, select unit 210 may allocate resource tags for entries of a reorder buffer, load/store buffers, or other downstream resources that may be utilized during instruction execution.

Generally, decode unit 215 may be configured to prepare the instructions selected by select unit 210 for further processing. Decode unit 215 may be configured to identify the particular nature of an instruction (e.g., as specified by its opcode) and to determine the source and sink (i.e., destination) registers encoded in an instruction, if any. In some embodiments, decode unit 215 may be configured to detect certain dependencies among instructions, to remap architectural registers to a flat register space, and/or to convert certain complex instructions to two or more simpler instructions for execution. Additionally, in some embodiments, decode unit 215 may be configured to assign instructions to slots for subsequent scheduling. In one embodiment, two slots 0-1 may be defined, where slot 0 includes instructions executable in load/store unit 245 or execution units 235-240, and where slot 1 includes instructions executable in execution units 235-240, floating-point/graphics unit 255, and any branch instructions. However, in other embodiments, other numbers of slots and types of slot assignments may be employed, or slots may be omitted entirely.

Register renaming may facilitate the elimination of certain dependencies between instructions (e.g., write-after-read or “false” dependencies), which may in turn prevent unnecessary serialization of instruction execution. In one embodiment, rename unit 220 may be configured to rename the logical (i.e., architected) destination registers specified by instructions by mapping them to a physical register space, resolving false dependencies in the process. In some embodiments, rename unit 220 may maintain mapping tables that reflect the relationship between logical registers and the physical registers to which they are mapped.

Once decoded and renamed, instructions may be ready to be scheduled for execution. In the illustrated embodiment, pick unit 225 may be configured to pick instructions that are ready for execution and send the picked instructions to issue unit 230. In one embodiment, pick unit 225 may be configured to maintain a pick queue that stores a number of decoded and renamed instructions as well as information about the relative age and status of the stored instructions. During each execution cycle, this embodiment of pick unit 225 may pick up to one instruction per slot. For example, taking instruction dependency and age information into account, for a given slot, pick unit 225 may be configured to pick the oldest instruction for the given slot that is ready to execute.

In some embodiments, pick unit 225 may be configured to support load/store speculation by retaining speculative load/store instructions (and, in some instances, their dependent instructions) after they have been picked. This may facilitate replaying of instructions in the event of load/store misspeculation. Additionally, in some embodiments, pick unit 225 may be configured to deliberately insert “holes” into the pipeline through the use of stalls, e.g., in order to manage downstream pipeline hazards such as synchronization of certain load/store or long-latency FGU instructions.

Issue unit 230 may be configured to provide instruction sources and data to the various execution units for picked instructions. In one embodiment, issue unit 230 may be configured to read source operands from the appropriate source, which may vary depending upon the state of the pipeline. For example, if a source operand depends on a prior instruction that is still in the execution pipeline, the operand may be bypassed directly from the appropriate execution unit result bus. Results may also be sourced from register files representing architectural (i.e., user-visible) as well as non-architectural state. In the illustrated embodiment, core 100 includes a working register file 260 that may be configured to store instruction results (e.g., integer results, floating-point results, and/or condition code results) that have not yet been committed to architectural state, and which may serve as the source for certain operands. The various execution units may also maintain architectural integer, floating-point, and condition code state from which operands may be sourced.

Instructions issued from issue unit 230 may proceed to one or more of the illustrated execution units for execution. In one embodiment, each of EXU0 235 and EXU1 240 may be similarly or identically configured to execute certain integer-type instructions defined in the implemented ISA, such as arithmetic, logical, and shift instructions. In the illustrated embodiment, EXU0 235 may be configured to execute integer instructions issued from slot 0, and may also perform address calculation and for load/store instructions executed by LSU 245. EXU1 240 may be configured to execute integer instructions issued from slot 1, as well as branch instructions. In one embodiment, FGU instructions and multicycle integer instructions may be processed as slot 1 instructions that pass through the EXU1 240 pipeline, although some of these instructions may actually execute in other functional units.

In some embodiments, architectural and non-architectural register files may be physically implemented within or near execution units 235-240. It is contemplated that in some embodiments, core 100 may include more or fewer than two integer execution units, and the execution units may or may not be symmetric in functionality. Also, in some embodiments execution units 235-240 may not be bound to specific issue slots, or may be differently bound than just described.

Load store unit 245 may be configured to process data memory references, such as integer and floating-point load and store instructions and other types of memory reference instructions. LSU 245 may include a data cache 250 as well as logic configured to detect data cache misses and to responsively request data from L2 cache 105. In one embodiment, data cache 250 may be configured as a set-associative, write-through cache in which all stores are written to L2 cache 105 regardless of whether they hit in data cache 250. As noted above, the actual computation of addresses for load/store instructions may take place within one of the integer execution units, though in other embodiments, LSU 245 may implement dedicated address generation logic. In some embodiments, LSU 245 may implement an adaptive, history-dependent hardware prefetcher configured to predict and prefetch data that is likely to be used in the future, in order to increase the likelihood that such data will be resident in data cache 250 when it is needed.

In various embodiments, LSU 245 may implement a variety of structures configured to facilitate memory operations. For example, LSU 245 may implement a data TLB to cache virtual data address translations, as well as load and store buffers configured to store issued but not-yet-committed load and store instructions for the purposes of coherency snooping and dependency checking LSU 245 may include a miss buffer configured to store outstanding loads and stores that cannot yet complete, for example due to cache misses. In one embodiment, LSU 245 may implement a store queue configured to store address and data information for stores that have committed, in order to facilitate load dependency checking LSU 245 may also include hardware configured to support atomic load-store instructions, memory-related exception detection, and read and write access to special-purpose registers (e.g., control registers).

Floating point/graphics unit 255 may be configured to execute and provide results for certain floating-point and graphics-oriented instructions defined in the implemented ISA. For example, in one embodiment FGU 255 may implement single- and double-precision floating-point arithmetic instructions compliant with the IEEE 754-1985 floating-point standard, such as add, subtract, multiply, divide, and certain transcendental functions. Also, in one embodiment FGU 255 may implement partitioned-arithmetic and graphics-oriented instructions defined by a version of the SPARC® Visual Instruction Set (VIS™) architecture, such as VIS™ 2.0 or VIS™ 3.0. In some embodiments, FGU 255 may implement fused and unfused floating-point multiply-add instructions. Additionally, in one embodiment FGU 255 may implement certain integer instructions such as integer multiply, divide, and population count instructions. Depending on the implementation of FGU 255, some instructions (e.g., some transcendental or extended-precision instructions) or instruction operand or result scenarios (e.g., certain denormal operands or expected results) may be trapped and handled or emulated by software.

In one embodiment, FGU 255 may implement separate execution pipelines for floating-point add/multiply, divide/square root, and graphics operations, while in other embodiments the instructions implemented by FGU 255 may be differently partitioned. In various embodiments, instructions implemented by FGU 255 may be fully pipelined (i.e., FGU 255 may be capable of starting one new instruction per execution cycle), partially pipelined, or may block issue until complete, depending on the instruction type. For example, in one embodiment floating-point add and multiply operations may be fully pipelined, while floating-point divide operations may block other divide/square root operations until completed.

Embodiments of FGU 255 may also be configured to implement hardware cryptographic support. For example, FGU 255 may include logic configured to support encryption/decryption algorithms such as Advanced Encryption Standard (AES), Data Encryption Standard/Triple Data Encryption Standard (DES/3DES), the Kasumi block cipher algorithm, and/or the Camellia block cipher algorithm. FGU 255 may also include logic to implement hash or checksum algorithms such as Secure Hash Algorithm (SHA-1, SHA-256, SHA-384, SHA-512), or Message Digest 5 (MD5). FGU 255 may also be configured to implement modular arithmetic such as modular multiplication, reduction and exponentiation, as well as various types of Galois field operations. In one embodiment, FGU 255 may be configured to utilize the floating-point multiplier array for modular multiplication. In various embodiments, FGU 255 may implement several of the aforementioned algorithms as well as other algorithms not specifically described.

The various cryptographic and modular arithmetic operations provided by FGU 255 may be invoked in different ways for different embodiments. In one embodiment, these features may be implemented via a discrete coprocessor that may be indirectly programmed by software, for example by using a control word queue defined through the use of special registers or memory-mapped registers. In another embodiment, the ISA may be augmented with specific instructions that may allow software to directly perform these operations.

As previously described, instruction and data memory accesses may involve translating virtual addresses to physical addresses. In one embodiment, such translation may occur on a page level of granularity, where a certain number of address bits comprise an offset into a given page of addresses, and the remaining address bits comprise a page number. For example, in an embodiment employing 4 MB pages, a 64-bit virtual address and a 40-bit physical address, 22 address bits (corresponding to 4 MB of address space, and typically the least significant address bits) may constitute the page offset. The remaining 42 bits of the virtual address may correspond to the virtual page number of that address, and the remaining 18 bits of the physical address may correspond to the physical page number of that address. In such an embodiment, virtual to physical address translation may occur by mapping a virtual page number to a particular physical page number, leaving the page offset unmodified.

Such translation mappings may be stored in an ITLB or a DTLB for rapid translation of virtual addresses during lookup of instruction cache 205 or data cache 250. In the event no translation for a given virtual page number is found in the appropriate TLB, memory management unit 270 may be configured to provide a translation. In one embodiment, MMU 270 may be configured to manage one or more translation tables stored in system memory and to traverse such tables (which in some embodiments may be hierarchically organized) in response to a request for an address translation, such as from an ITLB or DTLB miss. (Such a traversal may also be referred to as a page table walk or a hardware table walk.) In some embodiments, if MMU 270 is unable to derive a valid address translation, for example if one of the memory pages including a necessary page table is not resident in physical memory (i.e., a page miss), MMU 270 may be configured to generate a trap to allow a memory management software routine to handle the translation. It is contemplated that in various embodiments, any desirable page size may be employed. Further, in some embodiments multiple page sizes may be concurrently supported.

As noted above, several functional units in the illustrated embodiment of core 100 may be configured to generate off-core memory requests. For example, IFU 200 and LSU 245 each may generate access requests to L2 cache 105 in response to their respective cache misses. Additionally, MMU 270 may be configured to generate memory requests, for example while executing a page table walk. In the illustrated embodiment, L2 interface 265 may be configured to provide a centralized interface to the L2 cache 105 associated with a particular core 100, on behalf of the various functional units that may generate L2 accesses. In one embodiment, L2 interface 265 may be configured to maintain queues of pending L2 requests and to arbitrate among pending requests to determine which request or requests may be conveyed to L2 cache 105 during a given execution cycle. For example, L2 interface 265 may implement a least-recently-used or other algorithm to arbitrate among L2 requestors. In one embodiment, L2 interface 265 may also be configured to receive data returned from L2 cache 105, and to direct such data to the appropriate functional unit (e.g., to data cache 250 for a data cache fill due to miss).

During the course of operation of some embodiments of core 100, exceptional events may occur. For example, an instruction from a given thread that is selected for execution by select unit 210 may not be a valid instruction for the ISA implemented by core 100 (e.g., the instruction may have an illegal opcode), a floating-point instruction may produce a result that requires further processing in software, MMU 270 may not be able to complete a page table walk due to a page miss, a hardware error (such as uncorrectable data corruption in a cache or register file) may be detected, or any of numerous other possible architecturally-defined or implementation-specific exceptional events may occur. In one embodiment, trap logic unit 275 may be configured to manage the handling of such events. For example, TLU 275 may be configured to receive notification of an exceptional event occurring during execution of a particular thread, and to cause execution control of that thread to vector to a supervisor-mode software handler (i.e., a trap handler) corresponding to the detected event. Such handlers may include, for example, an illegal opcode trap handler configured to return an error status indication to an application associated with the trapping thread and possibly terminate the application, a floating-point trap handler configured to fix up an inexact result, etc.

In one embodiment, TLU 275 may be configured to flush all instructions from the trapping thread from any stage of processing within core 100, without disrupting the execution of other, non-trapping threads. In some embodiments, when a specific instruction from a given thread causes a trap (as opposed to a trap-causing condition independent of instruction execution, such as a hardware interrupt request), TLU 275 may implement such traps as precise traps. That is, TLU 275 may ensure that all instructions from the given thread that occur before the trapping instruction (in program order) complete and update architectural state, while no instructions from the given thread that occur after the trapping instruction (in program) order complete or update architectural state.

Additionally, in the absence of exceptions or trap requests, TLU 275 may be configured to initiate and monitor the commitment of working results to architectural state. For example, TLU 275 may include a reorder buffer (ROB) that coordinates transfer of speculative results into architectural state. TLU 275 may also be configured to coordinate thread flushing that results from branch misprediction. For instructions that are not flushed or otherwise cancelled due to mispredictions or exceptions, instruction processing may end when instruction results have been committed.

In various embodiments, any of the units illustrated in FIG. 2 may be implemented as one or more pipeline stages, to form an instruction execution pipeline that begins when thread fetching occurs in IFU 200 and ends with result commitment by TLU 275. Depending on the manner in which the functionality of the various units of FIG. 2 is partitioned and implemented, different units may require different numbers of cycles to complete their portion of instruction processing. In some instances, certain units (e.g., FGU 255) may require a variable number of cycles to complete certain types of operations.

Through the use of dynamic multithreading, in some instances, it is possible for each stage of the instruction pipeline of core 100 to hold an instruction from a different thread in a different stage of execution, in contrast to conventional processor implementations that typically require a pipeline flush when switching between threads or processes. In some embodiments, flushes and stalls due to resource conflicts or other scheduling hazards may cause some pipeline stages to have no instruction during a given cycle. However, in the fine-grained multithreaded processor implementation employed by the illustrated embodiment of core 100, such flushes and stalls may be directed to a single thread in the pipeline, leaving other threads undisturbed. Additionally, even if one thread being processed by core 100 stalls for a significant length of time (for example, due to an L2 cache miss), instructions from another thread may be readily selected for issue, thus increasing overall thread processing throughput.

As described previously, however, the various resources of core 100 that support fine-grained multithreaded execution may also be dynamically reallocated to improve the performance of workloads having fewer numbers of threads. Under these circumstances, some threads may be allocated a larger share of execution resources while other threads are allocated correspondingly fewer resources. Even when fewer threads are sharing comparatively larger shares of execution resources, however, core 100 may still exhibit the flexible, thread-specific flush and stall behavior described above.

### Branch Prediction

Turning now to FIG. 3, a block diagram of a multithreaded processor core 300 (which may be included within processor 10 and/or implement various features of core 100 in some embodiments) is depicted. As will be described below, in various embodiments, processor core 300 includes an instruction fetch unit that fetches instructions (possibly instructions from different threads) for execution on core 300. To facilitate the fetching of instructions, core 300 may include a branch predictor 330 and a branch predictor 340 that each generates predictions for a given control transfer instruction (i.e., some specific CTI) being executed on core 300. As instruction fetch unit 310 fetches instructions, it may determine whether those instructions include a control transfer instruction (non-limiting examples of CTIs include branches, calls, jumps, returns, and trap instructions). If fetch unit detects a CTI, the fetch unit may provide the fetch request to predictors 330 and 340 in order to determine whether the CTI is predicted to be taken or not taken. As will be described further below, predictor 330 may be lower latency than 340; accordingly, prediction information determined by predictor 330 can be used to go ahead and fetch a target address while prediction information is still being determined by predictor 340.

In the illustrated embodiment, core 300 includes an execution pipeline 302 that is representative of circuitry that is configured to execute instructions. In the embodiment shown, pipeline 302 includes an instruction fetch unit (IFU) 310, which, in turn, includes an instruction cache 312. In the illustrated embodiment, IFU 310 includes additional circuitry that is used to improve branch prediction performance of core 300. In some embodiments, this circuitry may be considered as part of execution pipeline 302. In various embodiments, execution pipeline 302 may include additional structures such as blocks 205-275 described above.

Instruction fetch unit (IFU) 310, in one embodiment, is configured to fetch instructions that are to be executed in pipeline 302. In various embodiments, IFU 310 may be configured to function in a similar manner to that of IFU 200 described above. In one embodiment, IFU 310 may be configured to select a thread during a given fetch cycle and to fetch one or more instructions in that thread from instruction cache 312. In some embodiments, IFU 310 may be configured to fetch a block of multiple instructions in multiple threads. In one embodiment, as IFU 310 fetches instructions, IFU 310 is configured to use branch prediction information to facilitate the fetching of instructions. In some embodiments, this prediction information may include predicted branch directions, predicted target addresses, etc.

In the illustrated embodiment, IFU 310 is configured to fetch instructions stored in instruction cache 312. These instructions are fetched based on the current fetch address, represented by fetch address block 320 in FIG. 3. In one embodiment, block 320 provides the current fetch address to instruction cache 312, as indicated by the output of 320 connected to instruction cache 312 in FIG. 3. Fetch address block 320 also provides information (e.g., a key or address) to look up information in branch predictors 330 and 340, discussed below. In one embodiment, the key provided from block 320 to predictor 330 includes the address provided to instruction cache 312, along with an identification of a current thread. In one embodiment, the key provided from block 320 to predictor 340 is a hash of the address provided to instruction cache 312 with the global branch history.

In one embodiment, the current value of element 320 (i.e., the current fetch address) is the output of a multiplexor/selection element 322. One input to element 322 is the output of multiplexor/selection element 332; the other is the output of branch predictor 340. Element 332 in turn is configured to select between the output of incrementer 328 and branch predictor 330. Accordingly, in the illustrated embodiment, the current fetch address can come from three different sources: incrementer 328, branch predictor 330, or branch predictor 340.

Incrementer 328 is configured to increment the current fetch address in some default manner. For example, if each fetch address causes 32 bytes to be fetched, increment 328 may cause the fetch address to be incremented by 32 each cycle. In one embodiment, absent a CTI in a group of instructions, the current fetch address will be updated based on incrementer 328.

In the illustrated embodiment, IFU 310 includes two different branch predictors: branch predictor 330 and branch predictor 340. When a CTI is encountered in a group of instructions, the address of that CTI is provided to both predictor 330 and predictor 340. Each predictor generates corresponding branch prediction information for the CTI. Thus, for a particular CTI (e.g., for the same occurrence of a branch instruction), direction and/or target information may be generated by both predictor 330 and predictor 340. (Note: conceptually, the techniques of the present disclosure may be extended to allow for more than two branch predictors if the particular design considerations and branch prediction techniques warrant.)

In general, one of the predictors (here, predictor 330) is configured to generate its prediction information before the other predictor. Accordingly, the two predictors can be distinguished by making some reference to the relative timing of their prediction outputs. As used herein, the later predictor (340) is referred to in some instances as the “delayed” predictor, although the other predictor (330) could just as easily be referred to as the “early” predictor. In one embodiment, predictor 340 implements any suitable branch prediction algorithm, and predictor 330 is used to generate a prediction that has a lower latency than that made by predictor 340. Further, core 300 may, in one embodiment, be configured to begin fetching instructions based on predictor 330 predicting (i.e., generating an output indicating) that a particular CTI will be taken.

While predictor 330 may be less accurate than predictor 340 in some instances, the use of predictor 330 to correctly predict CTIs may nonetheless reduce pipeline stalls due to the taken-branch penalty associated with predictor 340. For example, if predictor 340 has a three-cycle taken-branch penalty, the use of predictor 330 with a reduced taken-branch penalty (e.g., one cycle) may lead to measurable increase in processor performance and a corresponding decrease in power consumption.

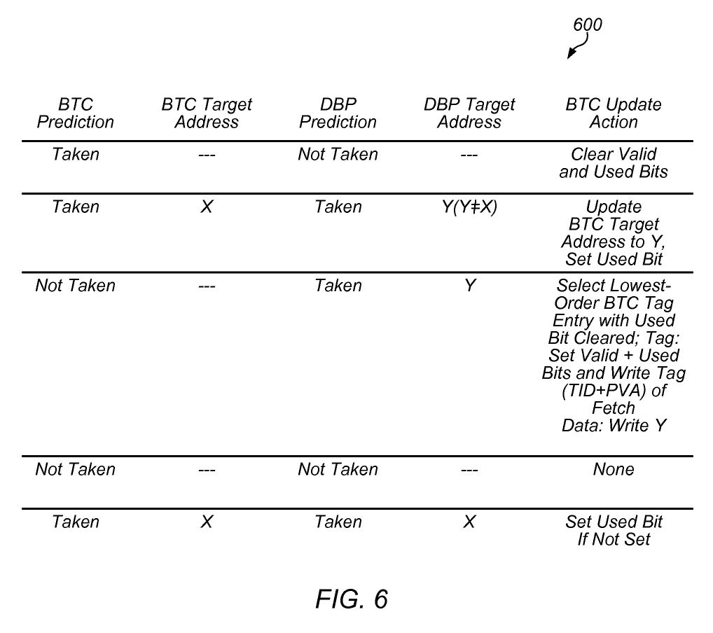

In one embodiment, IFU 310 includes an update unit 350 that is configured to receive the results of predictors 330 and 340 and update predictor 330 accordingly. Thus, where predictor 330's results are inconsistent with those of predictor 340, information in predictor 330 may be invalidated or updated. In this manner, the output of predictor 330 may be made more consistent with the output of predictor 340 upon a next occurrence of a particular CTI. For example, consider a conditional branch executed as part of a program loop. Upon a first pass through the loop, predictor 330 does not predict the branch to be taken, but predictor 340 does. In one embodiment, predictor 330 will be updated to predict the branch taken on successive iterations through the loop. One possible set of update actions is described further below with reference to FIG. 6.

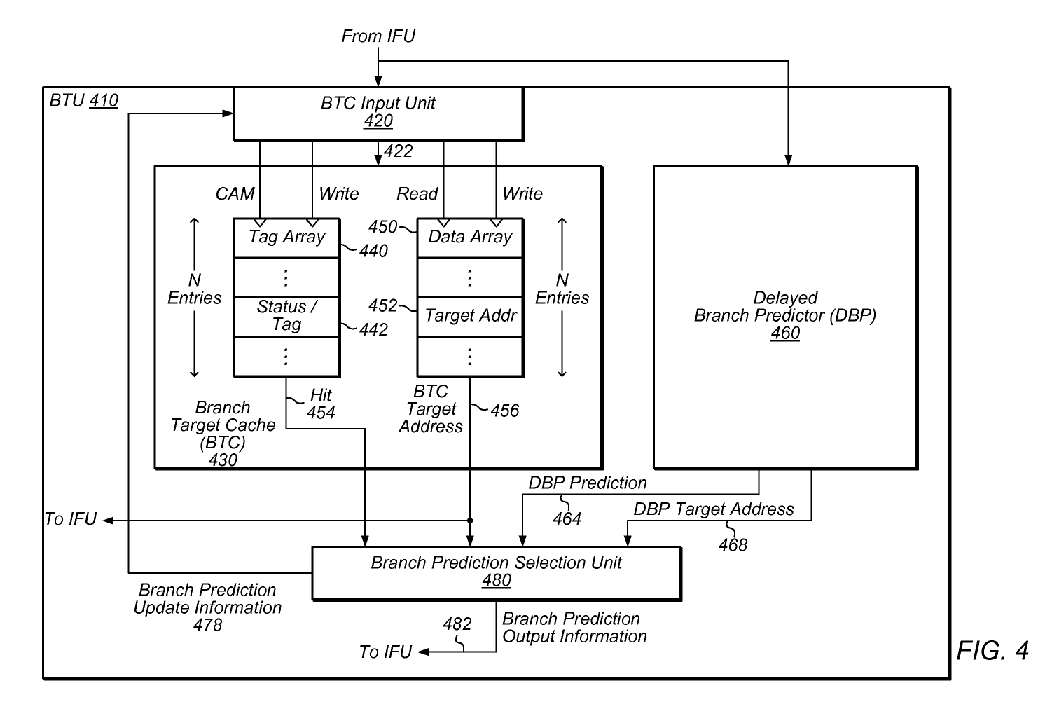

Turning now to FIG. 4, a block diagram of branch prediction unit (BPU) 410 is shown. As illustrated, BPU 410 includes BTC input unit 420, BTC 430, DBP 460, and branch prediction selection unit 480. BPU 410 includes more detail of one embodiment of an “early” branch prediction unit (here, branch target cache (BTC) 430). FIG. 4 also illustrates that this branch prediction circuitry may be situated in a location distinct from the IFU, in contrast to the embodiment of FIG. 3, in which predictors 330 and 340 were shown within IFU 310. Such circuitry may be located in any suitable logical block of core 300.

As described above with respect to FIG. 3, BPU 410 includes two branch predictors. In FIG. 4, these prediction units are referred to as BTC 430 and DBP 460. Fetch addresses from the IFU are presented to both of these predictors, as indicated by the arrows at the top of FIG. 4 entering BPU 410 from the IFU. In the embodiment shown, accesses to BTC 430 pass through BTC input unit 420, which ensures the proper control signals are generated. In one embodiment, unit 420 may generate control signals that perform a search for an entry in BTC 430 (a CAM operation) or write some or all of an entry in tag array 440 and/or data array 450. Unit 420 may perform an access to BTC 430 that specifies an update to the information stored in tag array 440; such an access may be based on receipt of a fetch address from the IFU, or on receipt of branch prediction update information 478.

In the embodiment shown, BTC 430 includes a tag array 440 and a data array 450, each of which has N entries. (In one particular embodiment, N=32). Tag array 440 permits BTC input unit 420 to determine whether a given fetch address has an entry in BTC 430 (and thus whether BTC 430 includes prediction information for the address). In one embodiment, unit 420 may generate a “key” for the given fetch address, and present this key to BTC 430 on bus 422. In one embodiment, the key is a portion (i.e., certain bits) of the current fetch address. In embodiments in which BPU 410 is located in a multithreaded processor, the key may be a concatenation (or some other arrangement) of a portion of the fetch address and an indication of the corresponding thread of the fetch address (e.g., the thread id), thus ensuring that activity in one thread does not influence the prediction of a CTI in another thread. In general, the key can have any suitable arrangement.

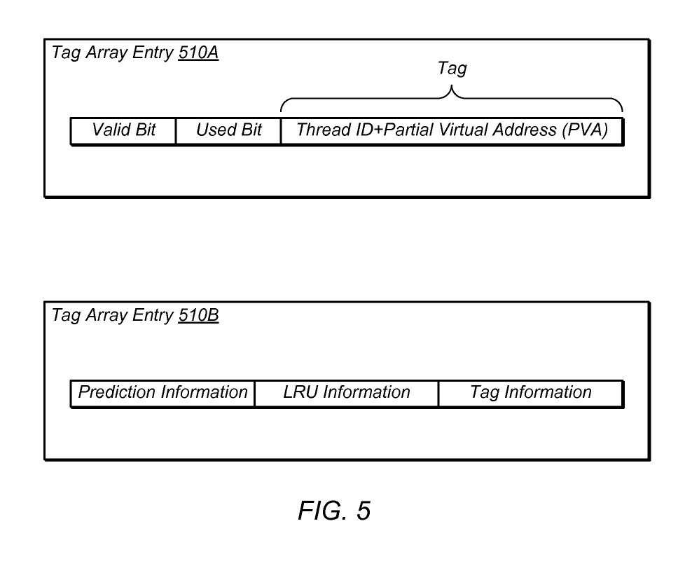

A representative entry 442 within array 440 is shown. Entry 442 includes a status portion and a tag portion. The status portion may, for example, indicate whether the entry is valid. The status portion may also include recent access information (e.g., for a replacement algorithm), as well as prediction information (e.g., whether a branch is to be taken; various counters may also be included in order to indicate whether the branch is strongly taken, weakly taken, etc.). Exemplary formats of entries in tag array 440 are described further with reference to FIG. 5.

In one embodiment, when a key is presented to tag array 440, each entry in the array is searched for a match for that value. Such a tag array may be referred to as a content-addressable memory (CAM), since the value being searched for, rather than an address to be accessed, is presented to the array. The act of presenting a key to tag array 440 may be referred to as a CAM operation. Such a tag array (and by extension, the BTC) is thus fully associative, since the key being searched for can reside in any one of the BTC's N entries. (The present disclosure also expressly contemplates BTCs that are not fully associative.) In one embodiment, a CAM operation is said to be a hit when the operation finds an entry in tag array 440 that 1) is valid and 2) includes a tag that matches the key; a CAM operation that does not have both of these properties is a miss. In one embodiment, tag array 440 indicates a successful CAM operation by asserting (or deasserting) hit signal 454; in such an embodiment, the deassertion (or assertion) of signal 454 can indicate a miss.

In the embodiment shown, tag array 440 includes one CAM port and one write port for updating tag array entries (discussed further below). Data array 450, whose entries include target addresses for corresponding tag entries, is implemented as a single-ported array with one read port and one write port. Other port configurations are possible in other embodiments.

In one embodiment, a BTC hit indicates that the current fetch has a branch that was predicted as being taken by DBP 460 on a prior occurrence of that branch (e.g., a previous iteration through a loop), and should be predicted as taken on the current occurrence of that branch. (In alternate embodiments, BTC 430 could generate this information without it first having been previously predicted by DBP 460.) The index of the entry in tag array that results in the match is called the hit index. In one embodiment, the CAM operation is followed by a read of the target address found at the hit index within data array 450, providing predicted BTC target address 456 (that is, the address to which the CTI shifts program flow upon being taken). Accordingly, the prediction information generated by BTC 430 in one embodiment includes a direction component (hit 454) and a target component (456).

In one embodiment, a BTC hit causes instructions at target address 456 to be fetched by the IFU. This prediction by the BTC might not be accurate in all instances. In one embodiment, every fetch initiated by the IFU also causes a lookup in the more accurate, but slower, DBP 460. Thus, in one implementation, a BTC prediction might take one clock cycle, while a DBP prediction might take three clock cycles. Thus, after receiving a fetch address from the IFU, DBP 460 generates prediction information with direction and target components: DBP prediction 464 and DBP target address 468. DBP may implement any suitable branch prediction algorithm, methodology, or design structure. In many instances, DBP 460 will have more data inputs than BTC 430, thus taking longer to produce results, but making the results more accurate in some cases.

The respective prediction information generated by BTC 430 and DBP 460 is presented to branch prediction selection unit 480. In one embodiment, the prediction information generated by DBP 460 controls or trumps the prediction information produced by BTC 430. Thus, if BTC 430 predicted a branch to be taken and DBP 460 predicts that the branch not to be taken, unit 480 selects the DBP 460 outputs as branch prediction output information 482 and conveys it to the IFU. Unit 480 also generates branch prediction update information 478 which is conveyed to unit 420 in order to update the tag and data array in the BTC in an appropriate fashion (e.g., by invalidating an entry so that it will no longer produce a hit, or by updating the data in an entry). In one embodiment, BTC 430 is updated so that on a next occurrence of the current CTI, the BTC will generate the results provided by the DBP for the current occurrence of the CTI. In this manner, the performance of the BTC may be improved. One possible set of update actions for BTC 430 is described further below with reference to FIG. 6.

Operation of BTC 430 may rely, in one embodiment, on a number of properties of CTI in typical program to achieve low-latency accurate predictions: First, CTIs in programs typically exhibit temporally locality—that is, a CTI that that has been referenced has a high likelihood of being referenced again in the near future. Second, the majority of CTIs will be predicted by DBP 460 in the same manner as their prior reference. For example, when a CTI is referenced as predicted to be taken by DBP 460, there is a high probability that on the next reference of the same CTI, DBP 460 will again predict the CTI to be taken. Finally, the target of a predicted-taken CTI will be the same as its prior reference. Accordingly, when these properties apply, BTC 430 can be used to cache DBP 460 predictions, and thus efficiently predict CTIs encountered in program flow, either for a single thread or multiple threads. This prediction scheme can lead not only to reduced latency, but also to reduced power consumption in some embodiments.

Turning now to FIG. 5, exemplary formats of entries in tag array 440 are shown. Tag array entry 510A (which is merely one possible implementation) includes a valid bit, a used bit, and a tag, which, in this embodiment, is a concatenation of an identifier of the thread corresponding to the CTI and a portion of the CTI's virtual fetch address.

In this implementation, when the valid bit is set for an entry (or reset as the case may be; the precise value of the valid bit is unimportant), any CTI that hits on this entry will be predicted to be taken by the BTC. The used bit allows the BTC to implement an entry replacement policy. Many different replacement policies are possible and contemplated. In one implementation, the used bit is set on each access to a particular entry, and, when adding a new entry to the BTC, the BTC writes to its “lowest-order” entry that does not have the used bit set. Thus, if the BTC includes entries 0-31, and entries 0-3 currently have the used bit set, and the used bit is not set for entry 4, upon the need to write a new BTC entry, entry 4 will be used. In one embodiment, upon the used bit being set for every entry in the BTC, all used bits may be cleared, allowing used bits to be set again upon further access.

The tag portion of tag array entry 510A is used to determine whether a BTC entry actually corresponds to a particular fetch address. Thus, a CTI for a first thread will not generate a BTC hit based on a CTI that may be taken in a second, different thread. Furthermore, in one embodiment, in order to generate a BTC hit, a portion of the virtual fetch address of the CTI will match the partial virtual address portion stored in entry 510A.

Exemplary tag array entry 510B is a generic version of entry 510A. Entry 510B is shown as including prediction information, LRU information, and tag information. Prediction information is any information that used to determine a prediction that is output from BTC 430. In one embodiment, the prediction information is simply a single valid bit; the presence of a valid entry in BTC 430 indicates that any fetch address matching on that entry is predicted to be taken. In other embodiments, multiple bits may be used, and the presence of a valid entry in the BTC 430 may not necessarily indicate that a corresponding CTI will be predicted to be taken. For example, consider an embodiment with a valid bit and two additional bits of prediction information. These two additional bits may indicate whether the CTI is strongly not-taken, weakly not-taken, weakly taken, or strongly taken. Many variations are possible.

Similarly, LRU information refers to any information that is used to implement a replacement policy for BTC 430. As indicated above, LRU information may be as simple as a single used bit per entry, or may include more information to allow for a more complex replacement scheme.

Finally, tag information refers to any information that is used to determine whether the BTC entry in question actually corresponds to the fetch address that is causing the BTC to be searched. As previously discussed, in one embodiment, the tag information may be a concatenation of other arrangement of the thread id and partial virtual address of the fetch address. Other formats are possible as well. In embodiments in which the BTC is fully associative, the tag information for all BTC entries may be checked for a given access.

Turning now to FIG. 6, a table 600 is shown that sets forth a list of exemplary update actions that may be taken with respect to BTC 430 based upon the respective branch predictions generated by BTC 430 and DBP 460 (or, more generically, first and second branch prediction units). Table 600 has five columns. The first and second columns correspond to the direction and target components of the branch prediction of BTC 430, while the third and fourth columns correspond to the same components of the branch prediction of DBP 460. The fifth column is the update action to be taken with respect to the BTC when the conditions described in columns one through four are met. As discussed below, an appropriate set of update actions for a given set of predictions may be “none.” Further, the set of update actions described relative to FIG. 6 are for a very specific implementation of BTC 430 and DBP 460. Accordingly, many different update actions are possible for different embodiments.

The first row of table 600 covers the situation in which there is a hit in the BTC for a particular CTI and the DBP subsequently predicts that the particular CTI is not taken. In this implementation, the BTC entry is invalidated such that a subsequent occurrence of the CTI will not cause a hit. In this embodiment, the used bit may also be cleared since it is no longer a valid entry. Further, instructions that may have been fetched based on the BTC hit may need to be discarded since the CTI is no longer predicted to be taken.

The second row of table 600 covers the situation in which the BTC and DBP both predict a hit, but to different target addresses. That is, the BTC predicts a control transfer to some address X and the DBP predicts a control transfer to some different address Y. In this implementation, the update action is to update the data array entry corresponding to the tag array entry that caused the hit, such that a subsequent occurrence of the instruction will predict a control transfer to the address currently indicated by the DBP. Further, the used bit in the tag array entry may be set (if not already) to indicate access. Also, instructions that may have been fetched based on the BTC hit may need to be discarded since the target was incorrect.

The third row of table 600 covers the situation in which the BTC predicts that a control transfer is not taken for a particular instruction, but the DBP predicts that the control transfer is taken (to an address Y). In this implementation, the BTC selects one of its entries in which to include the information for this CTI. In one embodiment, the BTC selects the lowest-order entry with the used bit cleared (other suitable selection policies are possible), and then writes appropriate values to the tag and data array. For example, the BTC sets the valid and used bits and the relevant tag information to the tag array, and then writes the target address Y (or some other indication thereof) to the corresponding entry in the data array. In this manner, the BTC may subsequently predict a control transfer on a subsequent occurrence of the CTI.

The fourth row of table 600 covers the situation in which neither the BTC nor the DBP predicts a control transfer instruction to be taken. In this implementation, no update to the BTC is performed.

The fifth row of table 600 covers the situation in which both the BTC and the DBP predict a control transfer to the same target address. In this implementation, the used bit for the relevant BTC tag array entry is set (if not already). Accordingly, if the entry was already in the cache but had its used bit reset, it will be set again to indicate a relatively recent access.

As noted above, the set of BTC update actions described in table 600 correspond to only one possible embodiment. This set of actions is designed such that when the BTC produces predictions inconsistent with the DBP for a CTI, the BTC is updated such that it will produce consistent results upon a next occurrence of the CTI (e.g., during the next iteration of a loop). In this manner, incorrect predictions associated with the reduced-latency prediction of the BTC may be minimized.

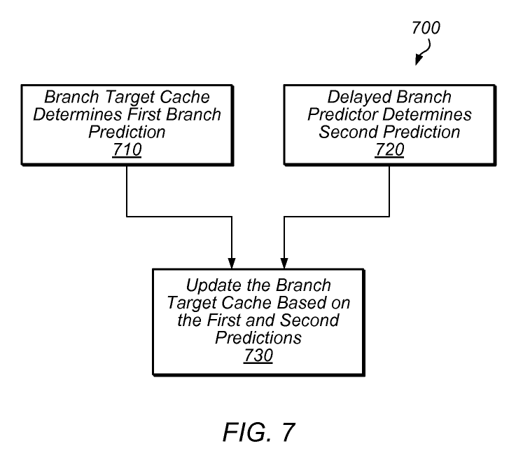

Turning now to FIG. 7, a flow diagram of one embodiment of a method 700 for performing branch prediction is depicted. As shown, method 700 includes steps 710, 720, and 730. Other variations of method 700 may include additional steps in different embodiments.

In method 700, two different branch predictions are computed. In step 710, a BTC (or, more generically, a first branch prediction unit) determines a first branch prediction. In step 720, a DBP (or, more generically, a second branch prediction unit) determines a second branch prediction. Steps 710 and 720 may overlap in time. In certain embodiments, steps 710 and 720 begin at approximately the same time (i.e., the same clock cycle), and the first branch prediction (the output of step 710) is generated before the second branch prediction (the output of step 720) is available. Thus, step 710 may be performed by BTC 430 in one embodiment, with step 720 performed by DBP 460.

Step 730 checks for any updates that need to be made to the BTC based on the first and second predictions. Thus, any changes to be made to the contents of the BTC (e.g., tag array or data array) may be made in this step. One exemplary set of rules for this step was described above relative to FIG. 6. Note that not all predictions will actually generate an update to the BTC (e.g., if steps 710 and 720 both indicate that a CTI is predicted to not be taken). Further note that the update to the BTC may be made based not only on the direction component of the prediction, but also on the target component. As described above, in one embodiment, even if both the first and second branch predictions indicate that a given CTI is predicted to be taken, a BTC update may still occur in step 730 if the respective targets of the predictions differ. Finally, the statement that a BTC update is “based on” the first and second predictions does not foreclose the possibility that the update could also be premised on other information.

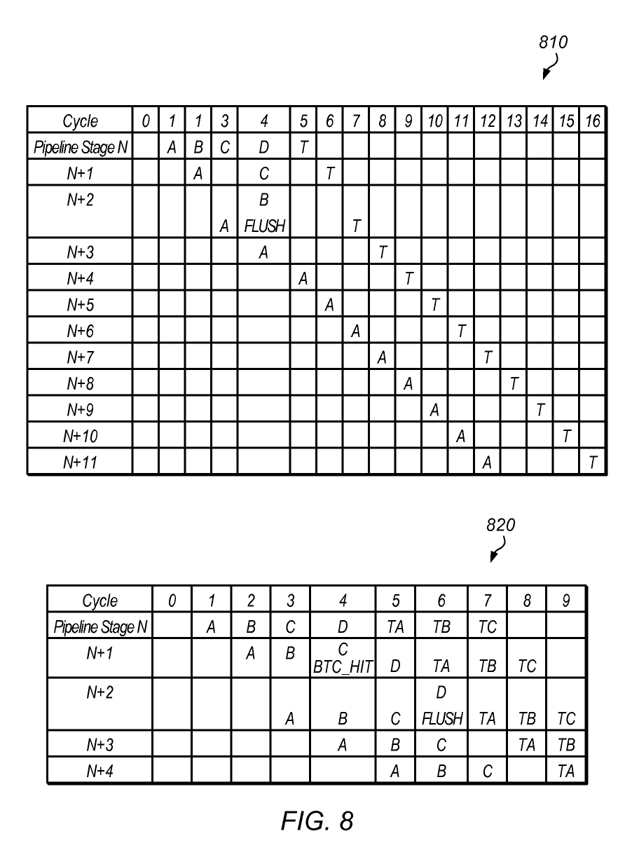

Turning now to FIG. 8, exemplary timing diagrams 810 and 820 are depicted. These diagrams are used to illustrate timing advantages that may be present in certain embodiments of the present disclosure. These diagrams are specific to one particular implementation; accordingly, corresponding diagrams may differ significantly for other embodiments.

Diagram 810 is used to illustrate the taken-branch penalty that would be present without the reduced-latency branch prediction of the present disclosure. Each row of diagram 810 corresponds to a different, successive pipeline stage of a processor on which a group of instructions are being executed. Each column corresponds to successive clock cycles of the processor. Instruction A is a taken branch with target address T. Instructions B, C, and D follow instruction A in program order. In this particular processor embodiment, in pipeline stage N+3, A is predicted to be a taken branch; instructions B, C, and D are flushed from the pipeline. There is accordingly a 3-cycle taken-branch penalty for this implementation (e.g., there are three wasted cycles between instruction A and instruction T for each pipeline stage shown in diagram 810).

Diagram 820 is used to illustrate the relative performance gains that may be achieved in one embodiment with a BTC according to one embodiment. Diagram 820 is arranged similarly to diagram 810. Instruction C in this example is a control transfer instruction predicted to be taken by the BTC in cycle 4. The target address is TA, which is fetched in the next cycle after the BTC hit is determined (cycle 5). The delayed branch predictor in this example has the same taken-branch penalty as shown above in diagram 810: three cycles. Accordingly, three cycles after instruction C is processed by pipeline stage N (cycle 6), C is predicted to be taken by the DBP, causing a flush of instruction D. Because a BTC hit was determined in cycle 4 and instruction TA fetched in cycle 5, there is only a one-cycle taken-branch penalty, as opposed, for example, to the three-cycle taken-branch penalty illustrated in diagram 810. In this manner, the BTC/DBP implementation can result in a decrease in pipeline stalls and thus improve performance in some instances.

### Exemplary System Embodiment

As described above, in some embodiments, processor 10 of FIG. 1 may be configured to interface with a number of external devices. One embodiment of a system 900 including processor 10 is illustrated in FIG. 9. In the illustrated embodiment, system 900 includes an instance of processor 10, shown as processor 10a, that is coupled to a system memory 910, a peripheral storage device 920 and a boot device 930. System 900 is coupled to a network 940, which is in turn coupled to another computer system 950. In some embodiments, system 900 may include more than one instance of the devices shown. In various embodiments, system 900 may be configured as a rack-mountable server system, a standalone system, or in any other suitable form factor. In some embodiments, system 900 may be configured as a client system rather than a server system.

In some embodiments, system 900 may be configured as a multiprocessor system, in which processor 10a may optionally be coupled to one or more other instances of processor 10, shown in FIG. 10 as processor 10b. For example, processors 10a-b may be coupled to communicate via their respective coherent processor interfaces 160.

In various embodiments, system memory 910 may comprise any suitable type of system memory as described above, such as FB-DIMM, DDR/DDR2/DDR3/DDR4 SDRAM, RDRAM®, flash memory, and of various types of ROM, etc. System memory 910 may include multiple discrete banks of memory controlled by discrete memory interfaces in embodiments of processor 10 that provide multiple memory interfaces 130. Also, in some embodiments, system memory 910 may include multiple different types of memory.

Peripheral storage device 920, in various embodiments, may include support for magnetic, optical, or solid-state storage media such as hard drives, optical disks, nonvolatile RAM devices, etc. In some embodiments, peripheral storage device 920 may include more complex storage devices such as disk arrays or storage area networks (SANs), which may be coupled to processor 10 via a standard Small Computer System Interface (SCSI), a Fibre Channel interface, a Firewire® (IEEE 1394) interface, or another suitable interface. Additionally, it is contemplated that in other embodiments, any other suitable peripheral devices may be coupled to processor 10, such as multimedia devices, graphics/display devices, standard input/output devices, etc. In one embodiment, peripheral storage device 920 may be coupled to processor 10 via peripheral interface(s) 150 of FIG. 1.

As described previously, in one embodiment boot device 930 may include a device such as an FPGA or ASIC configured to coordinate initialization and boot of processor 10, such as from a power-on reset state. Additionally, in some embodiments boot device 930 may include a secondary computer system configured to allow access to administrative functions such as debug or test modes of processor 10.

Network 940 may include any suitable devices, media and/or protocol for interconnecting computer systems, such as wired or wireless Ethernet, for example. In various embodiments, network 940 may include local area networks (LANs), wide area networks (WANs), telecommunication networks, or other suitable types of networks. In some embodiments, computer system 950 may be similar to or identical in configuration to illustrated system 900, whereas in other embodiments, computer system 950 may be substantially differently configured. For example, computer system 950 may be a server system, a processor-based client system, a stateless “thin” client system, a mobile device, etc. In some embodiments, processor 10 may be configured to communicate with network 940 via network interface(s) 160 of FIG. 1.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a first branch prediction unit configured to output, for a control transfer instruction in a group of instructions being executed by the apparatus, a first branch prediction indicating whether the control transfer instruction is predicted to be taken, wherein the apparatus is configured, in response to the first branch prediction unit predicting the control transfer instruction to be taken, to begin fetching a group of instructions at a target address;
a second branch prediction unit configured to subsequently output, for the control transfer instruction, a second branch prediction indicating whether the control transfer instruction is predicted to be taken;
wherein the apparatus is configured to discard the group of instructions in response to the second branch prediction indicating the control transfer instruction is predicted to not be taken.

2. The apparatus of claim 1, further comprising:
an update unit configured to determine whether to update information in the first branch prediction unit based on the first and second branch predictions.

3. The apparatus of claim 2, wherein the update unit is configured to update information in the first branch prediction unit with the second branch prediction such that, upon a next occurrence of the control transfer instruction, the first branch prediction unit outputs the second branch prediction.

4. The apparatus of claim 1, wherein the first branch prediction unit includes a plurality of entries, and wherein the first branch prediction unit is configured to simultaneously store entries for different ones of a plurality of threads being executed by the apparatus.

5. The apparatus of claim 1, wherein the first branch prediction unit stores respective prediction information and target addresses for a plurality of control transfer instructions.

6. The apparatus of claim 1, wherein the first branch prediction unit includes a tag array and a data array each having a respective plurality of entries, wherein the first branch prediction unit is configured to search all of the plurality of entries in the tag array to determine whether the control transfer instruction is predicted to be taken, and wherein, upon a hit on an entry in the tag array, the first branch prediction unit is configured to output an address stored in a corresponding entry in the data array as the target address of the control transfer instruction.

7. The apparatus of claim 2, wherein the first branch prediction unit includes a tag array having a plurality of entries, and wherein, in response to a hit on a first entry in the tag array indicating that the control transfer instruction is predicted to be taken and the second branch prediction unit indicating the control transfer instruction is predicted to not be taken, the update unit is configured to invalidate the first entry.

8. The apparatus of claim 2, wherein the first branch prediction unit includes a tag array having a plurality of entries and a data array having a corresponding plurality of entries, and wherein, in response to a hit on a first entry in the tag array indicating that the control transfer instruction is predicted to be taken to the target address specified in a corresponding entry in the data array and in further response to the second branch prediction unit indicating that the control transfer instruction is predicted to be taken to a different target address, the update unit is configured to update the corresponding entry in the data array to include the different target address.

9. The apparatus of claim 2, wherein the first branch prediction unit includes a tag array having a plurality of entries and a data array having a corresponding plurality of entries, and wherein, in response to a miss in the tag array indicating that the control transfer instruction is predicted to not be taken, and in further response to the second branch prediction unit indicating that the control transfer instruction is predicted to be taken, the update unit is configured to update a selected entry in the tag array and a corresponding entry in the data array such that the first branch prediction unit will predict a next occurrence of the control transfer instruction to be taken.

10. The apparatus of claim 2, wherein the first branch prediction unit includes a tag array having a plurality of entries, wherein the update unit is configured to set a used bit for entries in the first branch prediction unit that have been recently accessed, and wherein, in order to write a new set of data into the tag array, the update unit is configured to select a lowest-order of the plurality of entries that does not have the used bit set.

11. A method, comprising:
a branch target cache and a delayed branch predictor of a processor determining respective first and second predictions for whether a control transfer instruction being executed by a processing element is predicted to be taken, wherein the processing element is configured to fetch a group of instructions at a first target address in response to the first prediction indicating that the control transfer instruction is predicted to be taken; and
updating the branch target cache based on the first prediction and the second prediction.

12. The method of claim 11, wherein the branch target cache includes a plurality of entries and is fully associative, wherein determining the first and second predictions partially overlap in time, wherein determining the first prediction completes before determining the second prediction completes.

13. The method of claim 11, further comprising:
discarding the fetched group of instructions in response to the second prediction subsequently indicating that the control transfer instruction is predicted to not be taken.

14. The method of claim 11, wherein the first prediction is based on a first entry in the branch target cache, and wherein the updating includes:
upon the first prediction indicating that the control transfer instruction is predicted to be taken and upon the second prediction indicating that the control transfer instruction is predicted to be not taken, marking the first entry as invalid.

15. The method of claim 11, wherein the first prediction is based on a first entry in the branch target cache, and wherein the updating includes:
upon the first and second predictions both indicating that the control transfer instruction is predicted to be taken, but the first target address not matching a second target address associated with the second prediction, replacing the first target address in the first entry with the second target address.

16. The method of claim 11, wherein the first prediction is based on a first entry in the branch target cache, and wherein the updating includes:
upon the first prediction indicating that the control transfer instruction is predicted to be not taken and upon the second prediction indicating that the control transfer instruction is predicted to be taken, writing an entry in the branch target cache, wherein the entry includes a second target address output by the delayed branch predictor as part of the second prediction.

17. An apparatus, comprising:
a branch target cache configured to output cached branch prediction information for a control transfer instruction executed by the apparatus, wherein;
a delayed branch prediction unit configured to generate current branch prediction information for the control transfer instruction; and
an update unit configured, for the control transfer instruction, to update the cached branch prediction information based on the current branch prediction information.

18. The apparatus of claim 17, wherein, in response to the cached branch prediction information indicating that the control transfer instruction is predicted to be taken, the apparatus is configured to fetch a group of instructions from a target address specified by cached branch prediction information, wherein the branch target cache is configured to generate the cached branch prediction information before the delayed branch prediction unit generates the current branch prediction information, and wherein the apparatus is configured to discard instructions fetched as a result of the cached branch prediction information in response to the current branch prediction indicating the control transfer instruction is predicted to not be taken.

19. The apparatus of claim 17, wherein the branch target cache is configured to simultaneously store prediction information for a plurality of threads executable by the apparatus.

20. The apparatus of claim 19, wherein the branch target cache is fully associative.
